(19) United States
(12) Patent Application Publication
(10) Pub. No.: US 2026/0342147 A1
(43) Pub. Date: Oct. 29, 2026

(54) STATOR FOR ELECTRIC MOTOR

(71) Applicant: FANUC CORPORATION, Yamanashi (JP)

(72) Inventor: Makoto HAYASHI, Yamanashi (JP)

(21) Appl. No.: 18/995,143

(22) PCT Filed: Sep. 20, 2022
(86) PCT No.: PCT/JP2022/034981

§ 371 Date: Jan. 16, 2025

(51) Int. Cl. H02K 1/18; H02K 5/08

(52) U.S. Cl. CPC H02K 1/18; H02K 5/08

(57) ABSTRACT

This stator comprises: a housing which includes a core, a plurality of coils that are wound around the core, at least two support columns that contact an end surface of the core, and a bridge that mutually links the at least two support columns; and resin which covers the core, the plurality of coils, and the housing.

### RELATED APPLICATIONS

The present application is a National Phase of International Application No. PCT/JP2022/034981 filed Sep. 20, 2022.

### TECHNICAL FIELD

This disclosure relates generally to a stator for an electric motor.

### BACKGROUND ART

Conventionally, a stator of an electric motor is molded with resin for the purpose of waterproofing, etc. (for example, Patent Document 1). Molding is a method in which an insert is loaded into a mold, and then resin is injected into the mold. After the stator is loaded into the mold, resin is injected into the mold. As a result, the outside of the stator is covered with resin, and a part around a coil is filled with resin. To miniaturize the molded stator, it is necessary to reduce a thickness of the resin that covers the outside of the stator.

### CITATION LIST

### Patent Document

Patent Document 1: JP 2014-218063 A

### BRIEF DESCRIPTION OF THE DRAWINGS

FIG. 1A is a plan view of a stator before molding;

FIG. 1B is an exploded plan view of the stator before molding;

FIG. 1C is a right side view of the stator before molding;

FIG. 1D is a left side view of the stator before molding;

FIG. 2 is a plan view of the stator after molding;

FIG. 3A is an exploded perspective view of a core;

FIG. 3B is an exploded perspective view of the core;

FIG. 4 is a schematic view for describing a flow of resin during molding; and

FIG. 5 is a perspective view of a stator according to another embodiment.

### DETAILED DESCRIPTION

According to the disclosure, to reduce the thickness of the resin that covers the outside of the stator, it is necessary to narrow a gap between the mold and an outer part of the stator during molding. However, when the gap is narrowed, there is concern that the resin may insufficiently reach the gap during molding. In other words, there is concern that a molding defect may occur during molding. To avoid occurrence of the molding defect, injection pressure of the resin may be increased. However, when the injection pressure is increased, there is concern that a component of the stator such as a coil may be damaged.

For this reason, there is a need for technology that improves a flow of resin during molding without increasing injection pressure of the resin.

Hereinafter, a stator of an electric motor according to an embodiment of the disclosure will be described with reference to the drawings. In the following description, components having the same or similar functions are denoted by the same reference numerals. Furthermore, duplicate descriptions of those components may be omitted.

### One Embodiment

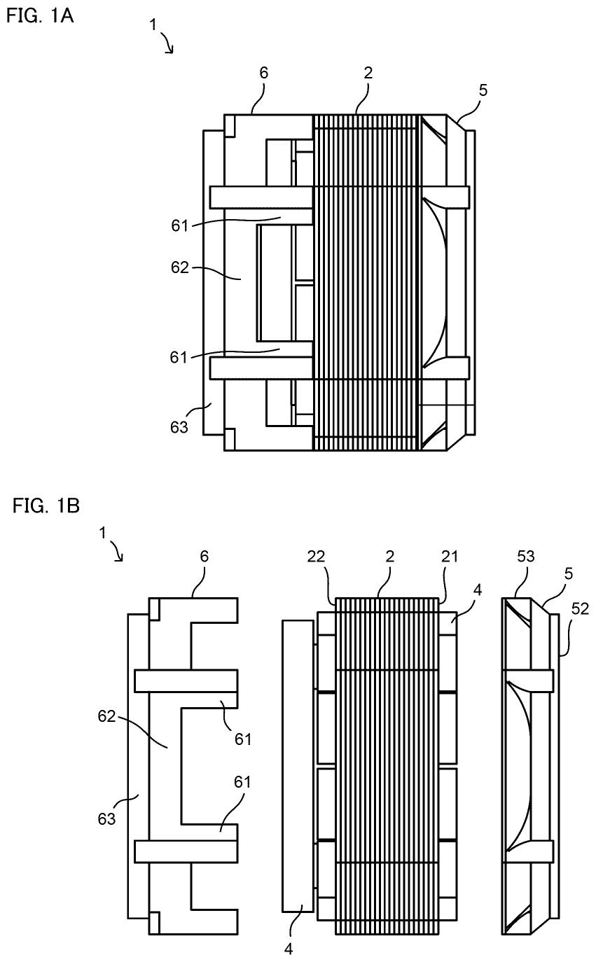

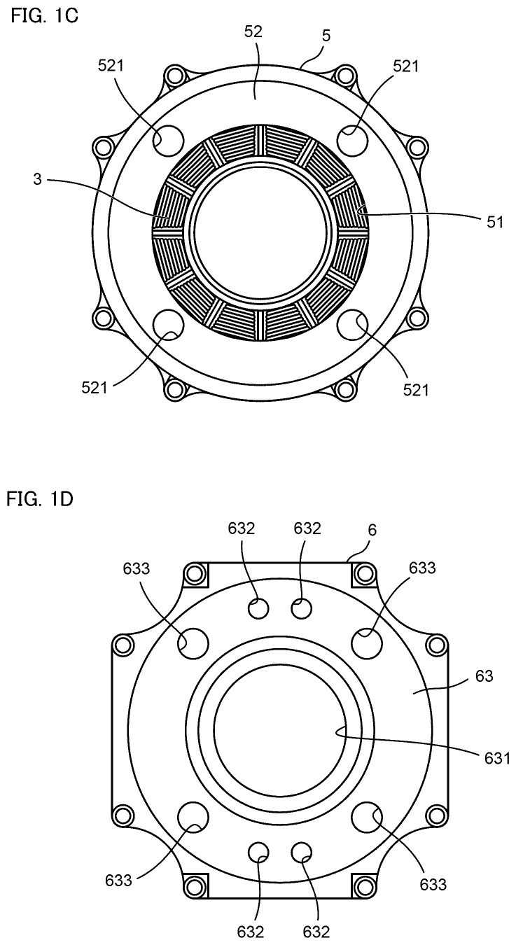

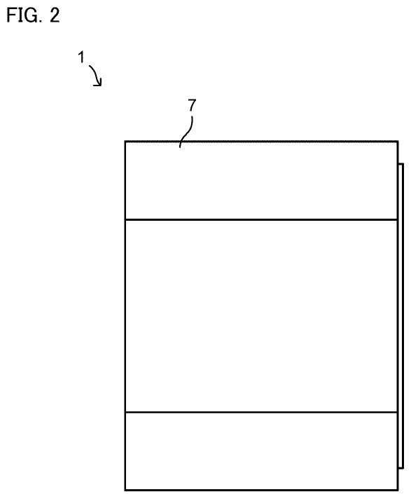

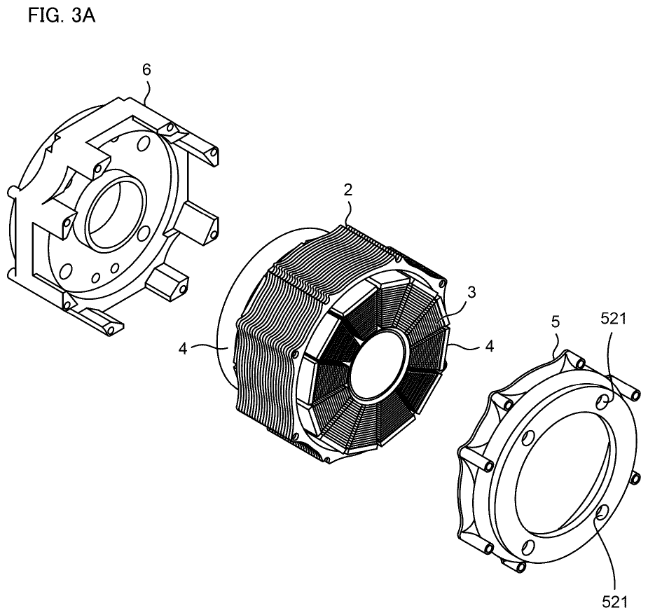

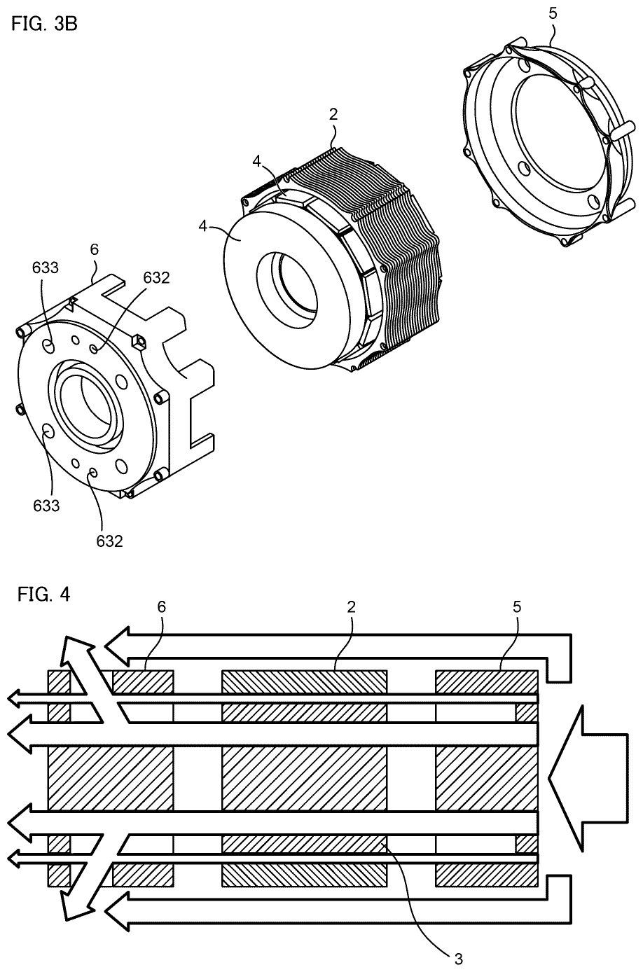

FIG. 1A is a plan view of a stator before molding. FIG. 1B is an exploded plan view of the stator before molding. FIG. 1C is a right side view of the stator before molding. FIG. 1D is a left side view of the stator before molding. FIG. 2 is a plan view of the stator after molding. FIGS. 3A and 3B are exploded perspective views of a core.

A stator 1 is a member constituting an electric motor. The stator 1 generates a magnetic force that rotates a rotor (not illustrated).

The stator 1 includes a core 2, a plurality of coils 3, an insulating portion 4, a first housing 5, a second housing 6, and a resin 7. Note that at least one of the first housing 5 and the second housing 6 corresponds to a housing described in the claims.

The core 2 is a component that serves as a path for magnetic flux. The core 2 is manufactured by stacking a plurality of plate materials formed by pressing, etc. The plate materials are, for example, electromagnetic steel plates.

The core 2 has a core back (not illustrated) formed in a substantially cylindrical shape, and teeth (not illustrated) extending from the core back toward a center.

The core 2 has a first end face 21 and a second end face 22. The first end face 21 is a surface constituting an end in a first direction along a central axis of the core 2. The second end face 22 is a surface constituting an end in a second direction along the central axis of the core 2. The second direction is the opposite direction to the first direction. Note that at least one of the first end face 21 and the second end face 22 corresponds to an end face described in the claims.

The plurality of coils 3 is wound around the teeth of the core 2. The coils 3 are made of, for example, copper wire.

The insulating portion 4 is a member interposed between the teeth and the coils 3 to insulate the teeth and the coils 3. The insulating portion 4 is formed using a predetermined insulating material. A printed circuit board (not illustrated) may be embedded in the insulating portion 4.

As illustrated in FIG. 3B, etc., when the insulating portion 4 covers sides of the coils 3, a hole for resin (not illustrated) may be formed in parallel to the central axis of the core 2 in the insulating portion 4. The hole for resin formed in the insulating portion 4 is a hole through which the resin 7 passes when the stator 1 is molded. In addition, the hole for resin formed in the insulating portion 4 is a hole finally filled with the resin 7 when the stator 1 is molded.

The first housing 5 is a member that covers at least a part of the coils 3 wound around the core 2. The first housing 5 is attached to the first end face 21 of the core 2 using, for example, screws, or bolts and nuts.

A central hole 51 is formed in the first housing 5. The central hole 51 is a circular through-hole whose center is the central axis of the core 2.

The first housing 5 includes at least an end face member 52 and an outer circumferential member 53. The end face member 52 is a member perpendicular to the central axis of the core 2. The outer circumferential member 53 is, for example, a member perpendicular to the end face member 52 and extending toward the first end face 21 of the core 2. The first housing 5 is integrally molded, for example, by casting.

In the end face member 52, one or more holes for resin 521 are formed parallel to the central axis of core 2. The holes for resin 521 are through-holes.

The holes for resin 521 are holes through which the resin 7 passes when the stator 1 is molded. In addition, the holes for resin 521 are holes finally filled with the resin 7 when the stator 1 is molded.

The holes for resin 521 are formed at positions corresponding to spaces between the coils 3. Each of the spaces between the coils 3 is a space between two coils wound around one tooth and another tooth adjacent to each other, respectively. That is, the holes for resin 521 are formed so that the holes for resin 521 and the spaces between the coils 3 are aligned in a straight line.

The second housing 6 is a member that covers at least a part of the coils 3 wound around the core 2. The second housing 6 is attached to the second end face 22 of the core 2 using, for example, screws, or bolts and nuts.

The second housing 6 has at least two pillars 61, a bridge 62, and an end face member 63. The at least two pillars 61, the bridge 62, and the end face member 63 are integrally formed by, for example, casting.

The at least two pillars 61 are members that abut against the second end face 22 of the core 2. Each of the pillars 61 extends parallel to the central axis of the core 2. A cross section of each pillar 61 may have any shape. Here, the cross section refers to a cross section perpendicular to the central axis of the core 2.

The bridge 62 is a member that connects the at least two pillars 61 to each other. The bridge 62 connects one ends of the respective pillars 61 to each other. Here, the one ends of the respective pillars 61 refer to ends located on the opposite side of ends abutting against the second end face 22 of the core 2.

A gap is formed between the second end face 22 of the core 2 and the bridge 62. In other words, in a state in which the second housing 6 is attached to the core 2, a hole is formed at a position surrounded by the second end face 22, the two pillars 61, and the bridge 62. This gap or hole allows the resin 7 to pass therethrough during molding, as described below. Furthermore, this gap is finally filled with the resin 7 by molding.

The end face member 63 is a member perpendicular to the central axis of the core 2. The end face member 63 covers the coils 3 and the insulating portion 4. A central hole 631 is formed in the end face member 63. The central hole 631 is a circular through-hole centered on the central axis of the core 2.

In the end face member 63, component attachment holes 632 are formed around the central hole 631. The component attachment holes 632 are, for example, screw holes. After the stator 1 is molded, various components are attached to the stator 1 using bolts, etc.

In the end face member 63, one or more holes for resin 633 are formed parallel to the central axis of the core 2. The holes for resin 633 are through-holes. The holes for resin 633 are holes through which the resin 7 passes when the stator 1 is molded. In addition, the holes for resin 633 are holes finally filled with the resin 7 when the stator 1 is molded.

The resin 7 covers at least the core 2, the coils 3, and the housing. That is, the resin 7 covers the stator 1 by molding.

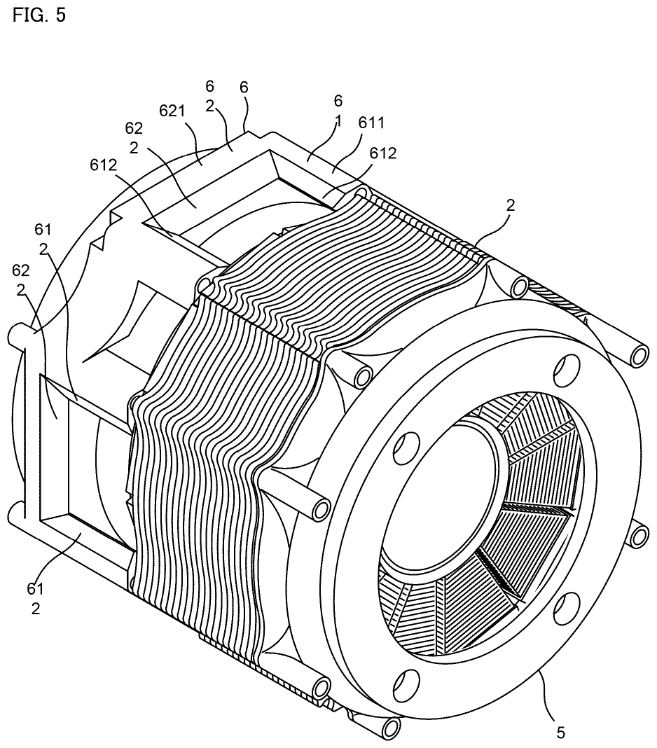

FIG. 4 is a schematic view for describing a flow of the resin 7 during molding. The stator 1 is molded by an injection molding machine while being loaded into a mold. Specifically, the resin 7 flowing from an injection port (not illustrated) for the resin 7 collides with the end face member 52 of the first housing 5, or flows along an outer surface of the outer circumferential member 53 without colliding with the end face member 52.

The resin 7 flowing along the outer surface of the outer circumferential member 53 flows in a direction in which the second housing 6 is disposed. As a result, an outer surface of the stator 1 is covered with the resin 7.

In addition, the resin 7 flowing from the injection port collides with the end face member 52 of the first housing 5, or flows from the central hole 51 of the first housing 5 toward the inside of the first housing 5 without colliding with the end face member 52. Furthermore, the resin 7 flowing from the injection port flows from the holes for resin 521 formed in the end face member 52 of the first housing 5 toward the inside of the first housing 5.

The resin 7 flowing inside the first housing 5 passes between the coils 3 wound around the core 2. Here, the coils 3 refer to the coils 3 wound around one tooth. Therefore, the space between the coils 3 refers to a gap that exists between coils 3 wound around two adjacent teeth, respectively.

A part of the resin 7 passing between the coils 3 flows out from a gap formed between the second end face 22 of the core 2 and the bridge 62 of the second housing 6. In addition, the remainder of the resin 7 passing between the coils 3 flows toward the inside of the second housing 6. The resin 7 flowing toward the inside of the second housing 6 flows out from the holes for resin 633 formed in the end face member 63 of the second housing 6. Note that, since a mold is disposed at a central portion of the stator 1 where the rotor is assembled, the resin 7 does not flow to the central portion.

### Another Embodiment

FIG. 5 is a perspective view of a stator 1 according to another embodiment. The bridge 62 of the second housing 6 has an inclined surface 622 along a direction from an outer surface 621 of the bridge 62 toward the coils 3. The outer surface 621 of the bridge 62 is a surface of the bridge 62 parallel to the central axis of the core 2.

The inclined surface 622 along the direction toward the coils 3 is a surface formed by bending the outer surface 621 of the bridge 62 by a predetermined angle toward the central axis of the core 2. In this case, one end of the inclined surface 622 is disposed at the same height as that of an outer peripheral surface of the core 2. That is, the outer surface 621 of the bridge 62 is formed on the same plane as that of the outer peripheral surface of the core 2. Note that the same plane does not necessarily have to be strictly the same plane. In addition, the other end of the inclined surface 622 facing the one end is disposed inside the core 2 with respect to the outer peripheral surface of the core 2.

An inclination angle of the inclined surface 622 is, for example, in a range of 10 to 45° from the outer surface 621 of the bridge 62. An angle of the inclined surface 622 may be, for example, 30°. Note that the inclined surface 622 formed on the bridge 62 may be a curved surface rather than a flat surface. In other words, the inclined surface 622 may have any shape as long as the resin smoothly flows from a gap between the bridge 62 and the core 2 during molding.

In addition, the pillar 61 may have an inclined surface 612 along a direction from the outer surface 611 of the pillar 61 toward the central axis of the core 2. The outer surface 611 of the pillar 61 is a surface of the pillar 61 formed on the same plane as that of the outer surface 621 of the bridge 62. The inclined surface 612 along a direction toward the central axis of the core 2 is a surface formed by bending the outer surface 611 of the pillar 61 toward the central axis of the core 2 by a predetermined angle.

An inclination angle of the inclined surface 612 is, for example, in a range of 10 to 45° from the outer surface 611 of the pillar 61. An angle of the inclined surface 612 may be, for example, 30°. Note that the inclined surface 612 formed on the pillar 61 may be a curved surface rather than a flat surface.

The stator 1 according to each of the above embodiments includes the core 2, the plurality of coils 3 wound around the core 2, the housing having the at least two pillars 61 abutting against the end face of the core 2 and the bridge 62 connecting the at least two pillars 61 to each other, and the resin 7 covering the core 2, the plurality of coils 3, and the housing.

Therefore, when the stator 1 is molded, the resin 7 flows out from a gap formed between the end face of the core 2 and the bridge 62. As a result, the flow of the resin 7 when the stator 1 is molded is improved. In this way, it is possible to prevent a molding defect.

When this gap is not formed, in other words, when the gap is covered by the second housing 6, the flow of the resin 7 in the corresponding portion covering the gap becomes poor. For example, when a distance between the second housing 6 and the mold is narrow in the corresponding portion, there is concern that the resin 7 may insufficiently reach the corresponding portion. The stator 1 in the present embodiment solves such a problem.

Further, the holes for resin 633 are formed in the end face member 63 of the housing, and the holes for resin 633 are filled with the resin 7. That is, when the stator 1 is molded, the resin 7 passes through the holes for resin 633. In this way, the flow of the resin 7 during molding is further improved. When molding is completed, the holes for resin 633 are filled with the resin 7.

Furthermore, the bridge 62 has the inclined surface 622 along the direction from the outer surface 621 of the bridge 62 toward the coils 3. Furthermore, the pillar 61 has the inclined surface 612 along the direction from the outer surface 611 of the pillar 61 toward the central axis of the core 2. In this way, during molding, the resin 7 passing between the coils 3 smoothly flows out from the gap between the second end face 22 and the bridge 62. In other words, the flow of the resin 7 during molding is further improved.

Furthermore, one end of each of the inclined surface 622 and the inclined surface 612 is disposed at the same height as that of the outer peripheral surface of the core 2, and the other end facing the one end is disposed on an inner side of the outer peripheral surface of the core 2. Therefore, the resin 7 flowing out from the gap between the second end face 22 of the core 2 and the bridge 62 smoothly merges with the resin 7 flowing along the outer peripheral surface of the core 2. In other words, the flow of the resin 7 during molding is improved.

Even though the disclosure has been described in detail, the disclosure is not limited to the above-mentioned individual embodiments. Various additions, substitutions, modifications, partial deletions, etc. are possible in these embodiments without departing from the gist of the disclosure, or without departing from the gist of the disclosure derived from contents described in the claims and equivalents thereto. In addition, these embodiments can be implemented in combination.

The following is a supplemental note on the embodiments of the disclosure.

### Supplemental Note [1]

A stator comprising: a core; a plurality of coils wound around the core; a housing having at least two pillars abutting against an end face of the core and a bridge connecting the at least two pillars to each other; and a resin covering the core, the plurality of coils, and the housing.

### Supplemental Note [2]

The stator according to supplemental note [1], wherein: a hole for resin is formed in an end face of the housing, and the hole for resin is filled with the resin.

Supplemental note [3]

The stator according to supplemental note [1] or [2], wherein the hole for resin is formed at a position corresponding to a space between coils of the plurality of coils.

### Supplemental Note [4]

The stator according to any one of supplemental notes [1] to [3], wherein the pillar has an inclined surface along a direction from an outer surface of the pillar toward a central axis of the core.

Supplemental note [5]

The stator according to any one of supplemental notes [1] to [4], wherein the bridge has an inclined surface along a direction from an outer surface of the bridge toward the plurality of coils.

Supplemental note [6]

The stator according to supplemental note [4] or [5], wherein one end of the inclined surface is disposed at the same height as a height of an outer peripheral surface of the core, and the other end facing the one end is disposed on an inner side of the outer peripheral surface of the core.

1. A stator comprising:
a core;
a plurality of coils wound around the core;
a housing having at least two pillars abutting against an end face of the core and a bridge connecting the at least two pillars to each other; and
a resin covering the core, the plurality of coils, and the housing.

2. The stator according to claim 1, wherein:
a hole for resin is formed in an end face of the housing, and
the hole for resin is filled with the resin.

3. The stator according to claim 2, wherein the hole for resin is formed at a position corresponding to a space between coils of the plurality of coils.

4. The stator according to claim 1, wherein the pillar has an inclined surface along a direction from an outer surface of the pillar toward a central axis of the core.

5. The stator according to claim 1, wherein the bridge has an inclined surface along a direction from an outer surface of the bridge toward the plurality of coils.

6. The stator according to claim 4, wherein one end of the inclined surface is disposed at the same height as a height of an outer peripheral surface of the core, and the other end facing the one end is disposed on an inner side of the outer peripheral surface of the core.
